(19) United States
(12) Patent Application Publication
(10) Pub. No.: US 2002/0100336 A1
(43) Pub. Date: Aug. 1, 2002

(54) Attachment structure for position-detecting sensors

(75) Inventor: Koji Sakurai, Koshigaya-shi (JP)

Correspondence Address: KODA & ANDROLIA, Suite 3850, 2029 Century Park East, Los Angeles, CA, 90067-3024, US

(73) Assignee: SMC CORPORATION

(21) Appl. No.: 10/054,204

(22) Filed: Nov. 13, 2001

(30) Foreign Application Priority Data
Jan. 26, 2001 (JP) 2001-019075

(51) Int. Cl. G01D 21/00

(52) U.S. Cl. 73/866.5

(57) ABSTRACT

The sensor attachment mechanism includes a rail member provided on an outer side surface of cylinder tube of a sensor, sensor attachment grooves to which the position-detecting sensors are installed provided in the rail member, and groove cover members which are installed in all of the sensor attachment grooves not occupied by the position-detecting sensors in order to prevent the invasion and accumulation of fluids and the like.

### BACKGROUND OF THE INVENTION

1. Field of the Invention

The present invention relates to an attachment structure for position-detecting sensors having a function to adjust their detection position.

2. Description of the Related Art

A fluid pressure-operated cylinder has been hitherto used as a driving means for transporting and positioning a workpiece and driving various industrial machines. In order to meet various needs of the user, for example, miniaturization and improvement of multiple functions in option setting or the like, the fluid pressure-operated cylinder is provided with a cylinder tube and accessory parts such as switches attached to the cylinder tube.

If liquid exists on the outer surfaces of a cylinder tube and a switch, various germs may be propagated in the liquid. Therefore, the present applicant proposed a sanitary position-detecting sensor. According to this prior art position-detecting sensor, liquid naturally drips down from the surfaces of the cylinder tube and the switch. Therefore, there is not much liquid on the surfaces of the cylinder tube and the switch. Also, though the position-detecting sensor has a position-adjusting mechanism, the main body of the position-detecting sensor is small. Therefore, the overall position-detecting sensor has a small size and a light weight (see Patent Application Serial No. 2000-56437 and Patent Application Serial No. 2000-56440).

### SUMMARY OF THE INVENTION

The present invention is employed in connection with said proposals, having as an object to provide an attachment structure for position-detecting sensors in which the attachment position of the position-detecting sensors in the direction of stroke of a cylinder can be arbitrarily adjusted, there is very little liquid on the outer surface, and the sensor is kept sanitary.

In order to achieve this object, the present invention includes an attachment structure for position-detecting sensors for detecting positions of a piston accommodated in a cylinder chamber in a cylinder tube of the fluid pressure operated cylinder, the attachment structure including a sensor attachment mechanism for holding the position-detecting sensors so that the position-detecting sensors are separated by a predetermined spacing distance from an outer side surface of the cylinder tube of the fluid pressure operated cylinder and wherein the sensor attachment mechanism includes a rail member having sensor attachment grooves formed in the axial direction to which the position-detecting sensors are installed and which is secured to the outer side surface of the cylinder tube, and groove cover members which are inlayed into all sensor attachment grooves not occupied by the position-detecting sensors in order to prevent the invasion of liquids and the like into the sensor attachment grooves.

In this case, a chamfered curved portion having a predetermined radius of curvature may be formed on the side portion of said rail member. Further, the groove cover members may be formed of a flexible material containing rubber or resin. Further, clearance may be provided between the rail member and the outer side surface of the cylinder tube. Still further, sensor attachment grooves may be formed on the side surface of the cylinder tube so that position-detecting sensors and groove cover members can be installed directly with respect to the sensor attachment grooves.

Also, the groove cover members may be shaped to correspond to the cross sectional form of the sensor attachment grooves and formed with curved portions having a circular arc-shaped cross section for the part which projects from the sensor attachment grooves and is externally exposed.

In accordance with the present invention, liquid pools are prevented and adhered liquid drips and falls spontaneously, because a sensor attachment mechanism is provided having a rail member secured to an outer side surface of the cylinder tube on which sensor attachment grooves are formed for installing position-detecting sensors, and groove cover members are utilized to cover the sensor attachment grooves not occupied by position-detecting sensors.

In accordance with the present invention, the following effects are obtained. Parts such as the rail member, which comprise the sensor attachment mechanism, are sealed by the groove cover members to prevent invasion of liquids adhered to the outer surface into the sensor attachment grooves. Moreover, liquid pooling does not occur and the sanitation problem is avoided, because liquid drips and falls spontaneously from curved portions and the like which are formed on the outer surfaces of said rail member.

### BRIEF DESCRIPTION OF THE DRAWINGS

The above and other objects, features, and advantages of the present invention will become more apparent from the following description when taken in conjunction with the accompanying drawings in which a preferred embodiment of the present invention is shown by way of illustrative example and like numerals represent like elements as follows:

FIG. 1 shows a perspective view illustrating a state in which position-detecting sensors are provided on a side surface of a liquid pressure cylinder by the aid of a sensor attachment mechanism according to an embodiment of the present invention;

FIG. 2 shows a front view illustrating the liquid pressure cylinder shown in FIG. 1;

FIG. 3 shows a longitudinal sectional view taken along a line III-III shown in FIG. 2;

FIG. 4 shows a magnified longitudinal sectional view illustrating portion A shown in FIG. 3;

FIG. 5 shows a partial magnified longitudinal sectional view illustrating a liquid pressure cylinder concerning Comparative Example;

FIG. 6 shows a front view illustrating the sensor attachment mechanism according to the embodiment of the present invention;

FIG. 7 shows a plane view illustrating the sensor attachment mechanism shown in FIG. 6;

FIG. 8 shows a side view illustrating the sensor attachment mechanism shown in FIG. 6;

FIG. 9 shows a perspective view illustrating a rail member which constitutes the sensor attachment mechanism shown in FIG. 6;

FIG. 10 shows a perspective view illustrating a state in which position-detecting sensors are provided on a side surface of a liquid pressure cylinder by the aid of a sensor attachment mechanism according to another embodiment of the present invention;

FIG. 11 shows a front view illustrating the liquid pressure cylinder shown in FIG. 10; and

FIG. 12 shows a side view illustrating the liquid pressure cylinder shown in FIG. 10.

### DESCRIPTION OF THE PREFERRED EMBODIMENTS

The attachment mechanism for position-detecting sensors of the present invention will be described in detail below as exemplified by the preferred embodiments and with reference to the attached drawings.

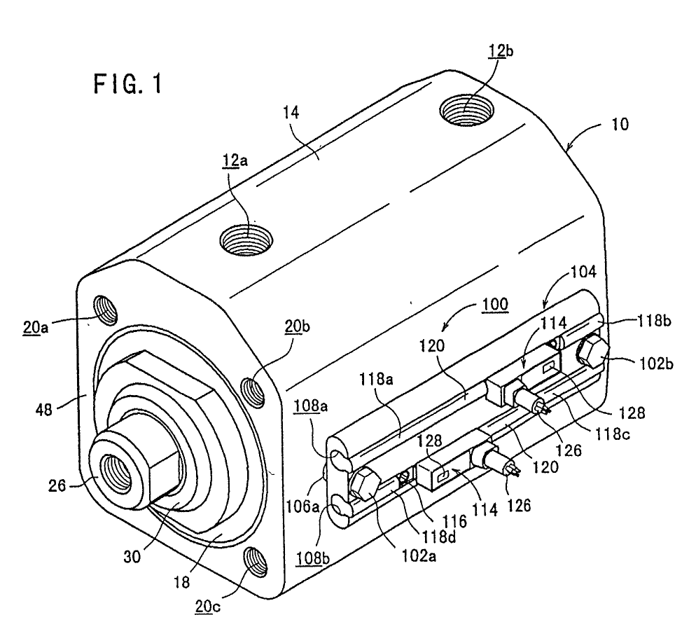

FIG. 1 shows a perspective view illustrating a state in which position-detecting sensors are provided on a side surface of a liquid pressure cylinder by the aid of a sensor attachment mechanism according to an embodiment of the present invention.

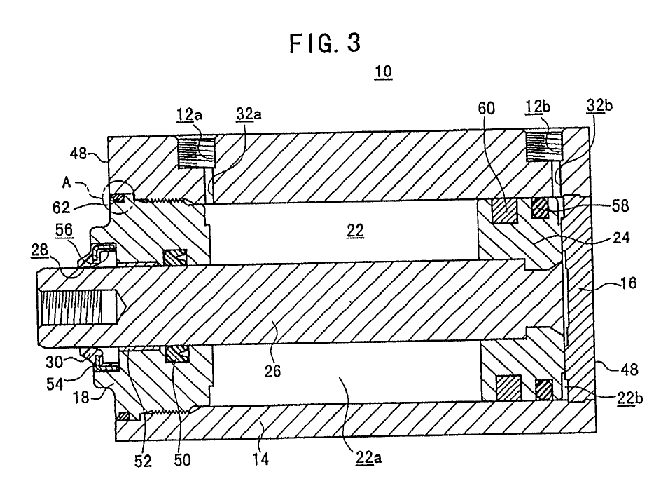

The fluid pressure cylinder 10 includes a substantially cylindrical cylinder tube 14 having a pair of pressure fluid inlet/outlet ports 12a and 12b separated from each other by a predetermined spacing distance, a head cover 16 secured to an end of the cylinder tube 14, and a rod cover 18 fitted into a screw hole on the other end of the cylinder tube 14 (see FIG. 3).

The cylinder tube 14 is formed with four attachment holes 20a to 20d which are provided in the axial direction. The cylinder 10 can be conveniently attached, for example, to a wall surface by screwing screw members, not illustrated, into screw portions of the attachment holes 20a to 20d or by inserting bolts, not illustrated, into the attachment holes 20a to 20d.

A shown in FIG. 3, the cylinder 10 further includes a piston 24 which is displaceable along a cylinder chamber 22 closed by the head cover 16 and the rod cover 18 in the cylinder tube 14, a piston rod 26 which has an end fastened to the piston 24 and the other end exposed to the outside, and a scraper 30 which is installed to an annular recess of the rod cover 18 and which is formed with a hole 28 for surrounding the outer circumferential surface of the piston rod 26.

The pair of pressure fluid inlet/outlet ports 12a and 12b are provided to make communication with the cylinder chamber 22 via passages 32a and 32b respectively.

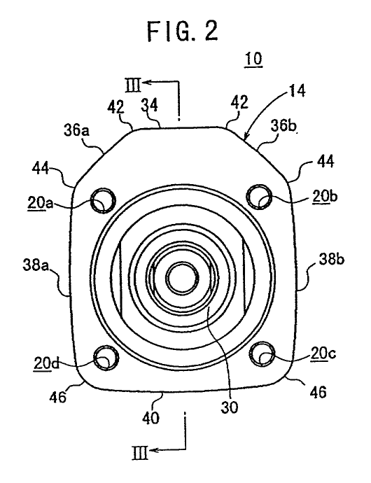

As shown in FIG. 2, the outer circumferential surface of the cylinder tube 14 includes, in the circumferential direction, an upper surface 34 which is formed with the pair of pressure fluid inlet/outlet ports 12a and 12b, a pair of inclined surfaces 36a and 36b which are continued to the upper surface 34 and which are inclined by predetermined angles, a pair of side surfaces 38a and 38b which are continued to the inclined surfaces 36a and 36b and which are opposed to one another, and a bottom surface 40 which is continued to the pair of side surfaces 38a and 38b respectively.

First chamfered sections 42, each of which has a predetermined radius of curvature, are formed at boundary portions between the upper surface 34 and the inclined surfaces 36a and 36b. Second chamfered sections 44, each of which has a predetermined radius of curvature, are formed at boundary portions between the inclined surfaces 36a and 36b and the side surfaces 38a and 38b. Third chamfered sections 46, each of which has a predetermined radius of curvature, are formed at boundary portions between the side surfaces 38a and 38b and the bottom surface 40.

In this arrangement, the upper surface 34, the pair of inclined surfaces 36a and 36b, the pair of side surfaces 38a and 38b, and the bottom surface 40, which constitute the outer circumferential surface of the cylinder tube 14, have predetermined radiuses of curvature respectively, and they are formed by curved surfaces which are convex toward the outside.

As described above, all of the outer circumferential surface portions of the cylinder tube 14, which are disposed in the circumferential direction of the cylinder tube 14, are constructed by the outwardly convex curved surfaces and the first to third chamfered sections 42, 44 and 46. Further, the other side surfaces except for the outer circumference surfaces disposed in the circumferential direction described above are formed as substantially vertical surfaces 48. Accordingly, the cylinder tube 14 is designed to have such a shape that any liquid adhered to the outer surface of the cylinder tube 14 spontaneously and easily drips and falls.

Therefore, no liquid pools appear, because no recess is formed on the outer circumferential surface of the cylinder tube 14 disposed in the circumferential direction. Also, it is possible to avoid a sanitation problem caused by various germs being propagated in the liquid.

As shown in FIG. 3, the head cover 16 is fitted into the hole of the cylinder tube 14. The connecting portion between the head cover 16 and the cylinder tube 14 forms a metal seal which retains the cylinder chamber 22 in an air-tight manner and prevents invasion of liquid or the like from the outside.

A rod packing 50 is installed to the inner circumferential surface of the rod cover 18 by the aid of an annular groove. The outer circumferential surface of the piston rod 26 is surrounded by the rod packing 50, and thus the cylinder chamber 22 is held in an air-tight and a liquid-tight manner. A cylindrical bushing 52 is installed in an annular recess which is formed on the inner circumferential surface of the rod cover 18. The scraper 30, in which a metal piece 54 is molded with a rubber material, is installed in an annular recess which is formed at the end of the rod cover 18. An annular chamber 56, which functions as an oil pool for lubricating oil adhered to the outer circumferential surface of the piston rod 26, is formed between the scraper 30 and the rod cover 18.

A piston packing 58, which makes sliding contact with the inner wall surface of the cylinder chamber 22 and which divides the cylinder chamber 22 into a first cylinder chamber 22a and a second cylinder chamber 22b, is installed on the outer circumferential surface of the piston 24 by the aid of an annular groove. Further, a magnet 60, which is composed of a ring member to surround the piston 24, is installed at a portion disposed in the vicinity of the piston packing 58 by the aid of an annular groove.

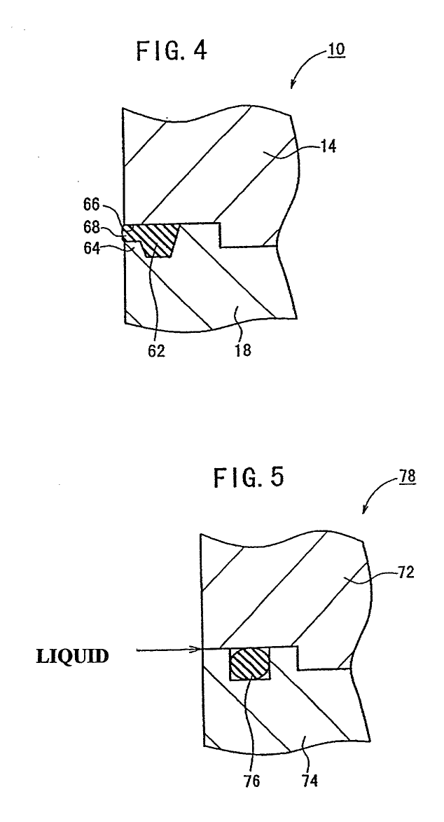

An annular seal member 62, which is formed of a flexible material such as rubber, is provided at one end of the connecting portion between the cylinder tube 14 and the rod cover 18 in the axial direction. As shown in FIG. 4, a part of the seal member 62 is installed in a state of being forcibly deformed and interposed by a narrow spacing distance between an inner circumferential surface 66 of the cylinder tube 14 and an annular projection 64 formed on the rod cover 18.

That is, the annular seal member 62, which is formed to have its substantially constant wall thickness in the circumferential direction, is previously provided with a press margin to be forcibly interposed between the inner circumferential surface 66 of the cylinder tube 14 and the annular projection 64 formed on the outer circumferential surface of the rod cover 18. Therefore, even when any liquid or the like might enter the connecting portion between the cylinder tube 14 and the rod cover 18, the sealing is reliably effected by a forcibly interposed section 68 of the seal member 62. Thus, the liquid or the like does not enter the cylinder tube 14.

A pair of screw holes (not shown), which are separated from each other by a predetermined spacing, are formed on the side surface of the cylinder tube 14 in order to attach a rail member as described later on.

As shown in FIGS. 1 and 6 to 9, the sensor attachment mechanism 100 includes a rail member 104 which is secured to the side surface of the cylinder tube 14 with a predetermined spacing by the aid of hexagon head bolts 102a and 102b, each of which has a hexagonal head, screwed into screw holes formed on the side surface of the cylinder tube 14, and a pair of ring members 106a and 106b whose bottom surface is formed to have a circular arc-shaped cross section having a predetermined radius of curvature corresponding to the curved side surface of the cylinder tube 14, and which are interposed between the rail member 104 and the side surface of the cylinder tube 14.

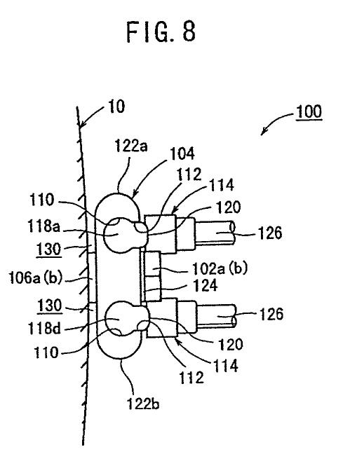

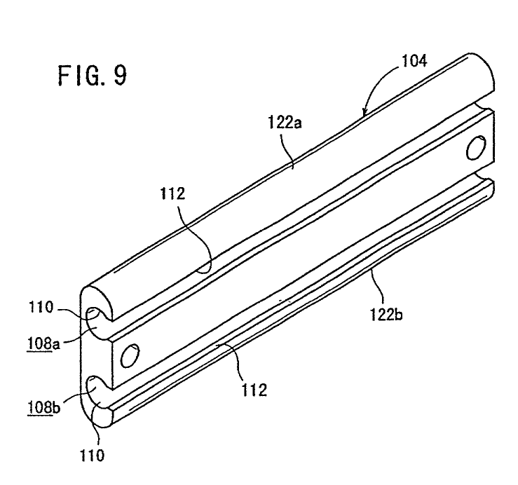

As shown in FIG. 9, a pair of sensor attachment grooves 108a and 108b are formed essentially parallel and extending in the axial direction of the elongated plate-shaped rail member 104. The sensor attachment grooves 108a (108b) have circular arc portions 110 formed with circular arc-shaped cross sections, and groove opening portions 112 formed so that the groove widths are substantially constant and are continued to the circular arc portions 110 (see FIG. 8).

In this arrangement, position-detecting sensors 114 formed with cross sections corresponding to the circular arc portions 110 are inserted into the circular arc portions 110, and the position-detecting sensors 114 are secured at the desired positions in the attachment grooves 108a and 108b by screwing in attachment screws 116 so that the end portions of the attachment screws 116 press the inner wall surface of the circular arc portions 110. Additionally, the positions of the position-detecting sensors 114 can be arbitrarily adjusted to a desired position within the sensor attachment grooves 108a and 108b by loosening the attachment screws 116 and moving the position-detecting sensors 114.

Further, the sensor attachment mechanism 100 includes groove cover members 118a to 118d in order to cover all sensor attachment grooves 108a and 108b not occupied by the position-detecting sensors 114 by performing a sealing function when installed in all sensor attachment grooves 108a and 108b not occupied by position-detecting sensors 114.

As shown in FIG. 8, the groove cover members 118a to 118d have a cross sectional form corresponding to the circular arc portions 110 of the sensor attachment grooves 108a and 108b and the groove opening portions 112; and further, the portions which project from the sensor attachment grooves 108a and 108b and are externally exposed have curved surfaces 120 formed with a circular arc-shaped cross section.

The groove cover members 118a to 118d, for example, are formed of a rubber material such as silicon rubber or fluoro rubber, or a flexible material containing resin, which are used by cutting them to the desired lengths corresponding to the installed positions of the position-detecting sensors 114.

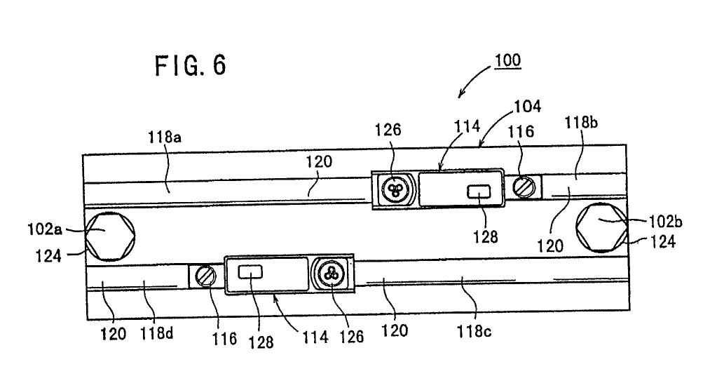

A pair of curved portions 122a and 122b with circular arc-shaped cross sections having outer surfaces each of which is chamfered to a predetermined radius of curvature, are formed on the opposing sides of the rail member 104. Therefore, it is formed so that any liquid adhered to the curved portions 122a and 122b of the rail member 104 spontaneously drips off and falls. A ring-shaped plain washer 124, which functions to prevent loosening, is installed to the head of each of the hexagon head bolts 102a and 102b (see FIGS. 6 and 8).

The rail member 104 may be formed of, for example, a synthetic resin material or a metal such as aluminum alloy and stainless steel.

The position-detecting sensors 114, which are formed of a different material and with a shape corresponding to the cross sectional shape of the sensor attachment grooves 108a (108b), are inserted into the sensor attachment grooves 108a (108b).

Attachment screws 116, which fasten the position-detecting sensors 114 at desired positions in the sensor attachment grooves 108a and 108b by extending through the position-detecting sensors 114 and pressing the inner wall surface of the attachment grooves 108a and 108b when screwed in, are provided at one end of the position-detecting sensors 114. Lead wires 126 are connected to the other end of the position-detecting sensors 114.

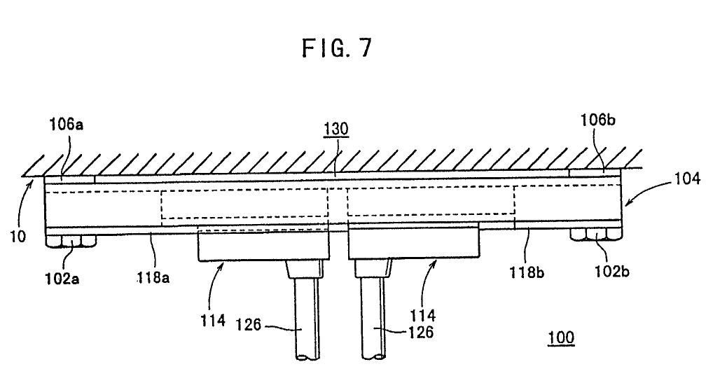

As shown in FIGS. 1 and 6, an indicator section 128 having an oblong shape, through which the emitted light from a light-emitting element, not illustrated, is visible when the magnet 60 of the piston 24 is sensed, is provided at an intermediate portion of the position-detecting sensors 114. The indicator section 128 is formed of a transparent or semitransparent member. An appropriate clearance 130 is provided between the rail member 104 and the side surface of the cylinder tube 14. The position-detecting sensors 114 are arranged in a non-contact state with respect to the outer surface of the cylinder tube (see FIGS. 7 and 8).

Since liquid pools may be generated when the position-detecting sensors 114 contact with the outer surface of the cylinder tube 14 as a result of drainage liquid adhered to the outer surface of the cylinder tube 14, it is preferable that the position-detecting sensors 114 are in a floating state by means of the appropriate clearance 130. In this case, it is preferable that the appropriate clearance 130 is, for example, about 1 to 2 mm.

An unillustrated detecting element, which is composed of, for example, a Hall element or a magnetoresistive element, is provided in the position-detecting sensors 114. A detection signal can be led to the external equipment via the lead wire 126.

The cylinder 10, to which the sensor attachment mechanism 100 according to this embodiment of the present invention is applied, is basically constructed as described above. Next, its operation, function, and effect will be explained.

A pressure fluid (for example, air) is supplied from a pressure fluid supply source, not illustrated, to the first pressure fluid inlet/outlet port 12a. The pressure fluid, which is supplied to the first pressure fluid inlet/outlet port 12a, is introduced into the first cylinder chamber 22a via the passage 32a. Accordingly, the piston 24 is pressed toward the second cylinder chamber 22b.

When the piston 24 arrives at the displacement terminal end position in accordance with the action of the pressure fluid, the magnetic field of the magnet 60 installed on the piston 24 is sensed by the detecting element, not shown, of the position-detecting sensor 114. The position-detecting sensor 114 feeds the detection signal to the external equipment such as a controller, not shown, via the lead wire 126.

When the supply of the pressure fluid is switched from the first pressure fluid inlet/outlet port 12a to the second pressure fluid inlet/outlet port 12b in accordance with the switching action of a directional control valve (not shown), then the piston 24 is displaced in the direction opposite to the above, and it is restored to the initial position. By doing so, the piston 24, which is accommodated in the cylinder tube 14, is successfully subjected to reciprocating movement along the cylinder chamber 22.

When the cylinder 10, which is equipped with the position-detecting sensors 114 by the aid of the sensor attachment mechanism 100, is assembled, for example, to a food processing machine (not shown) to perform, for example, a washing operation, then any liquid adhered to the outer surfaces of the cylinder tube 14 and the sensor attachment mechanism 100 drips and falls off with ease, and it is possible to avoid any occurrence of liquid pools on the outer surfaces of the cylinder tube 14 and the sensor attachment mechanism 100, because all of the outer circumferential surface of he cylinder tube 14 in the circumferential direction is constructed of convex curved surfaces, the first to third chamfered sections 42, 44 and 46 are convex toward the outside, and the side portions of the rail member 104 of the sensor attachment mechanism 100 are formed by the curved portions 122a and 122b, each of which has a predetermined radius of curvature.

Further, it is possible to prevent the invasion of liquid and the occurrence of liquid pool in the sensor attachment grooves 108a and 108b by inserting the groove cover members 118a to 118d to achieve a sealing function in all of the sensor attachment grooves 108a and 108b which are not occupied by the position-detecting sensors 114. In this case, liquid adhered to the outer surfaces of the groove cover members 118a to 118d spontaneously drips and falls off, because the portions which project from the sensor attachment grooves 108a and 108b and are externally exposed have the curved surfaces 120 formed with a circular arc-shaped cross section.

As described above, the cylinder 10, which is equipped with the position-detecting sensors 114 by the aid of the sensor attachment mechanism 100, has such a contour shape that the liquid barely adheres to the outer surface, and the adhered liquid spontaneously drips and falls off. Thus, it is possible to avoid the propagation of various germs, and it is possible to avoid a sanitation problem.

Further, the position-detecting sensors 114 can be positionally adjusted to and desired position in the sensor attachment grooves 108a and 108b by loosening the attachment screws 116. In this case, it is possible to set a large range of positional adjustments corresponding to the length of the rail member 104.

When the sensor attachment mechanism 100 is not used, the screw holes, which are formed on the side surface 38b of the cylinder 10, may be closed with closing means (not shown) such as bolts provided with seal washers.

Further, in case the positions of the position-detecting sensors 114 are changed, it is possible to conveniently achieve the sealing function for the sensor attachment grooves 108a and 108b by inserting into the sensor attachment grooves 108a and 108b new cover members which are cut to the desired lengths corresponding to the new positions set for the position-detecting sensors 114.

As shown in FIG. 4, the cylinder 10 uses the seal member 62 which is previously provided with a press margin to be forcibly interposed under pressure between the inner circumferential surface 66 of the cylinder tube 14 and the annular projection 64 formed on the outer circumferential surface of the rod cover 18. In contrast, as shown in FIG. 5, in the case of a cylinder 78 concerning the Comparative Example in which an O-ring 76 having a circular cross section is installed to a connecting portion between a cylinder tube 72 and a rod cover 74, the liquid or the like leaks to the outside at the portion at which the O-ring 76 is installed via the connecting portion between the cylinder tube 72 and the rod cover 74, and various germs are propagated due to the liquid or the like.

In other words, the O-ring 76, which is provided for the cylinder 78 concerning the Comparative Example, has only a function to avoid the leakage of the air in the cylinder chamber to the outside. The liquid, which leaks out via the connecting portion between the cylinder tube 72 and the rod cover 74, is capable of making further invasion up to the portion at which the O-ring 76 is installed. Therefore, various germs are propagated with ease due to the liquid.

In contrast, in the case of the cylinder 10, the sealing is reliably effected owing to the forcibly interposed section 68 of the seal member 62. Accordingly, it is possible to reliably prevent any leakage of liquid or the like to the outside from the cylinder tube 14 via the connecting portion between the cylinder tube 14 and the rod cover 18. As a result, the propagation of various germs, which would be otherwise caused by the liquid or the like escaping from the cylinder tube 14, is prevented.

The embodiment of the present invention has been explained as exemplified by the case in which the cylinder 10 is equipped with the position-detecting sensors 114. However, there is no limitation thereto. It is a matter of course that the present invention may be applied, for example, to various fluid pressure operated apparatuses such as linear actuators and electric actuators (not shown).

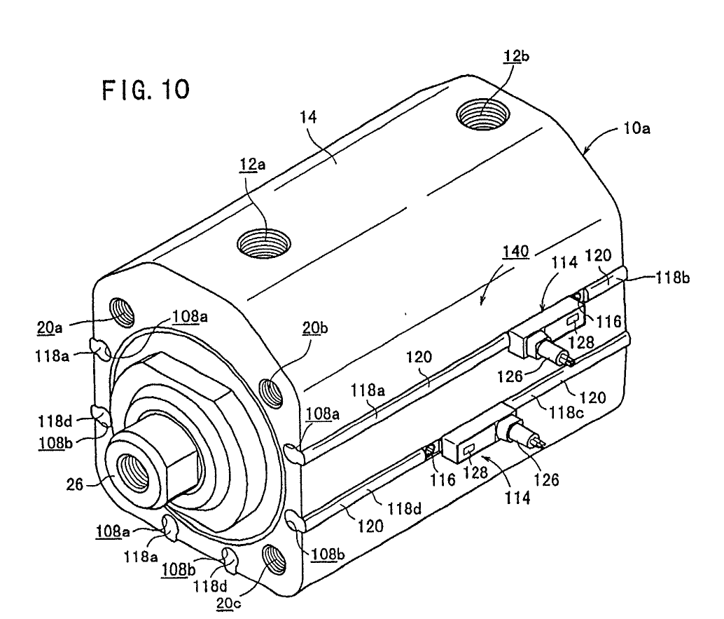

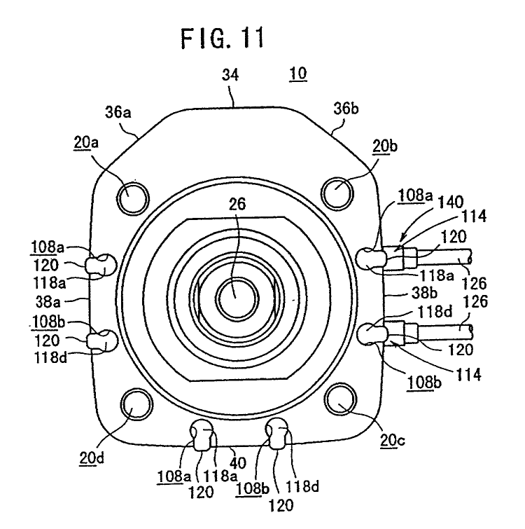

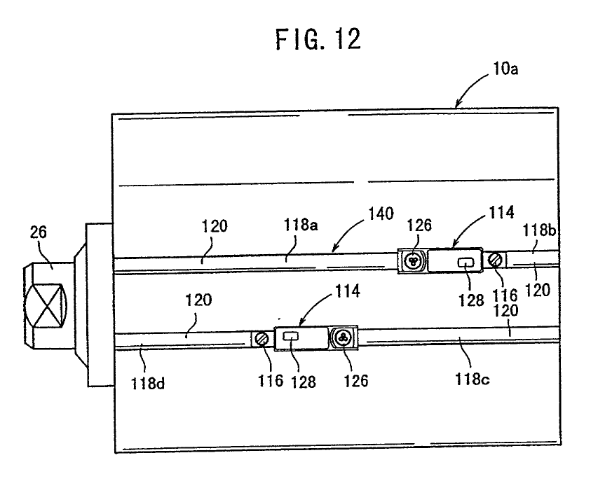

Next, a sensor attachment mechanism 140 according to another embodiment is shown in FIGS. 10 to 12. In the embodiment described below, the same constitutive components as those of the sensor attachment mechanism 100 shown in FIG. 1 are designated by the same reference numerals and a detailed explanation of which is omitted.

The sensor attachment mechanism 140 according to this another embodiment, differs in that, instead of using the rail member 104, essentially parallel pairs of sensor attachment grooves 108a and 108b are formed on each of three sides of the cylinder tube 14. The position-detecting sensors 114 and groove cover members 118a to 118d are installed directly to the cylinder 10 using sensor attachment grooves 108a and 108b.

The sensor attachment mechanism 140 according to this embodiment has the advantage of reducing cost by reducing the number of parts, because parts such as the rail member 104 and the pair of hexagon head bolts 120a and 102b are not required. A detailed explanation of other operational effects will be omitted, because they are the same as those of the sensor attachment mechanism 100 shown in FIG. 1.

While the invention has been particularly shown and described with reference to preferred embodiments, it will be understood that variations and modifications can be effected thereto by those skilled in the art without departing from the spirit and scope of the invention as defined by the appended claims.

What is claimed is:

1. An attachment structure for position-detecting sensors for detecting positions of a piston accommodated in a cylinder chamber in a cylinder tube, said attachment structure for said position-detecting sensors comprising:
a sensor attachment means for holding said position-detecting sensors so that said position-detecting sensors are separated by a predetermined spacing from an outer side surface of said cylinder tube, and
wherein said sensor attachment means includes a rail member having sensor attachment grooves formed in an axial direction of said cylinder chamber for installing said position-detecting sensors on said outer side surface of said cylinder tube, and groove cover means for being inserted into all sensor attachment grooves not occupied by said position-detecting sensors in order to prevent the invasion and accumulation of liquids in said sensor attachment grooves.

2. The attachment structure for said position-detecting sensors according to claim 1, wherein curved portions, each of which is chamfered with a predetermined radius of curvature, are formed on side portions of said rail member.

3. The attachment structure for said position-detecting sensors according to claim 1, wherein said groove cover means are formed of a flexible material selected from the group consisting of rubber or resin materials.

4. The attachment structure for said position-detecting sensors according to claim 1, wherein said predetermined spacing is provided between said rail member and the outer side surface of the cylinder tube.

5. The attachment structure for said position-detecting sensors according to claim 1 or 3, wherein said groove cover means are shaped to correspond to a cross sectional form of the sensor attachment grooves and are formed with curved portions having a circular arc-shaped cross section for a portion which projects from said sensor attachment grooves and is externally exposed.

6. The attachment structure for said position-detecting sensors according to claim 1, wherein said sensor attachment grooves are formed in the side surfaces of said cylinder tube, and position-detecting sensors and groove cover members are installed directly with respect to said sensor attachment grooves.
